(19) United States
(12) Patent Application Publication
(10) Pub. No.: US 2015/0179031 A1
(43) Pub. Date: Jun. 25, 2015

(54) SECURITY DEVICE

(71) Applicant: Robert F. Wallace, Fort Myers, FL (US)

(72) Inventor: Robert F. Wallace, Fort Myers, FL (US)

(21) Appl. No.: 14/578,035

(22) Filed: Dec. 19, 2014

Related U.S. Application Data
(60) Provisional application No. 61/918,619, filed on Dec. 19, 2013.

(51) Int. Cl. G08B 13/02; G08B 7/06; G08B 5/36

(52) U.S. Cl. CPC G08B 13/02; G08B 5/36; G08B 7/06

(57) ABSTRACT

An apparatus includes a housing having substantially the shape of a light bulb and including a base for coupling the housing to a light socket. The apparatus also includes an audible alarm mounted entirely within the housing and electrically coupled to the base to facilitate control of the audible alarm by a motion sensing device.

### CROSS-REFERENCE TO RELATED PATENT APPLICATIONS

The present application claims priority to U.S. Provisional Patent Application Ser. No. 61/918,619 entitled SECURITY BULB and filed on Dec. 19, 2013 by Robert F. Wallace, the full disclosure of which is hereby incorporated by reference.

### BACKGROUND

Motion sensing security lights are used in various applications to sense motion within a certain distance of the security light. For example, a motion sensing security light may be mounted outdoors (e.g., on a post, building, or other structure) in a position such that motion around the location of the security light may be detected. Motion sensing security lights typically include one or more light sources (e.g., an incandescent bulb, a fluorescent lamp, a halogen floodlight, etc.) located in sockets of the motion sensing security light. The light sources typically remain off until motion is detected by a motion sensing device in the motion sensing security light. When motion is detected, the motion sensing security light switches on the light sources so that the light sources illuminate the area around the location of the motion sensing security light. The additional illumination provided by the light sources may potentially aid in revealing the source of the detected motion in low light conditions.

### BRIEF DESCRIPTION OF THE DRAWINGS

FIG. 1 is a diagram illustrating an example security device including an audible device.

FIG. 2 is a diagram illustrating the security device of FIG. 1 installed in an example motion sensing security light fixture.

FIG. 3 is a flow diagram illustrating an example method of manufacturing the security device of FIG. 1.

FIG. 4 is a diagram of an example security device including an example control device for controlling an operating parameter of the security device.

FIG. 5 is a diagram of the security device of FIG. 1 further including an example light source.

FIG. 6 is a diagram of the security device of FIG. 1 further including example additional functions.

### DETAILED DESCRIPTION OF EXAMPLES

Examples of security devices for use with light fixtures such as motion sensing security light fixtures are disclosed herein. The security device may include a housing having substantially the shape of a light bulb, and a base for coupling the housing to a light socket. For example, the housing may be substantially shaped like a standard incandescent general service light bulb having a standard Edison screw base. Using a housing having substantially the shape of a standard light bulb, and a base for coupling the housing to a standard light socket may allow the security device to be compatible with a greater number of light fixtures without modification to the light fixture.

The security device may also include an audible device mounted within the housing and electrically coupled to the base to facilitate control of the audible alarm by a motion sensing device. For example, an alarm may be mounted entirely within the housing and electrically coupled to the base so that when the security device is installed in a light socket of a motion sensing security light fixture (e.g., in place of one of the standard light sources), the motion sensing security light fixture includes an audible alarm function that may be activated when motion is detected by a sensor in the motion sensing security light. Mounting the audible device entirely within the housing may allow the security device to avoid interference issues when used with light fixtures having shrouds designed for use with standard bulbs or lamps that may cover or conceal portions of the security device. Mounting the audible device in a housing having substantially the shape of a standard light bulb, and a base for coupling the housing to a standard light socket may allow, for example, an alarm function to be added to a greater number of light fixtures without modification to the light fixture.

The security device may also include an externally accessible control device supported by the housing and electrically coupled to the audible device to control an operating parameter of the audible device. For example, the security device may include externally accessible control devices such as switches or potentiometers to turn an alarm function on or off, to test the alarm function, to adjust the volume, pitch, duty cycle, frequency, and duration of the alarm function, etc. The control devices may be mounted on or integrated with the outer surface of the housing, or may be disposed internally and accessible by removing a cover panel of the housing. Including externally accessible control devices within the housing may allow the alarm function of the security device to be customized for a greater number of situations or applications.

The security device may also include a light source mounted within the housing and electrically coupled to the base. The housing may also include, for example, a lens for passing the light emitted by the light source. The security device may also include externally accessible control devices such as switches or potentiometers to, for example, turn the light source on or off, to test the light source, to adjust the intensity, duty cycle, frequency, and duration of the light source, etc. Including a light source in the security device may allow the light fixture to add an alarm function via a light socket while retaining a light source for that socket. Including externally accessible control devices within the housing may allow the light source of the security device to be customized for a greater number of situations or applications.

The security device may also include a motion sensing device mounted within the housing and electrically coupled to the base. In this way, the security device may be used to convert light fixtures that do not have motion sensing function into motion sensing security light fixtures having, for example, an alarm function. The security device may also include a camera mounted within the housing and electrically coupled to the base. In this way, the security device may add a camera function to a light fixture to potentially aid in revealing and/or recording the source of the detected motion. The security device may also include a photosensor mounted within the housing and electrically coupled to a light source in order to, for example, allow for automated and efficient enabling of a light source feature based on lighting conditions.

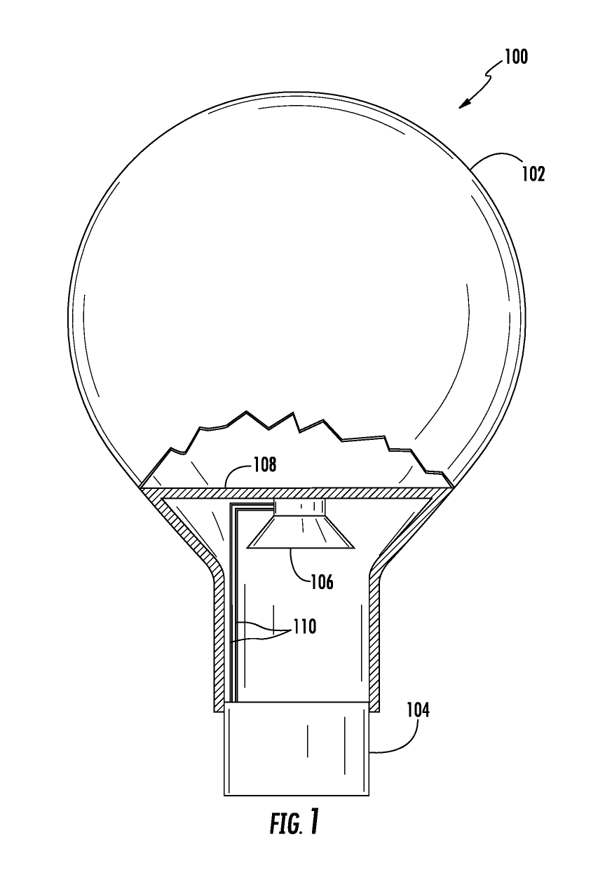

FIG. 1 is a diagram illustrating an example security device 100. In general, printhead assembly 100 may be used to add audible device functionality to a light fixture, such as a motion sensing security light fixture. As shown in FIG. 1, security device 100 may include a housing 102. Housing 102 may be in substantially the shape of a light bulb. The term “light bulb” as used herein includes light sources of the type typically used in light fixtures such as motion sensing security light fixtures, including, for example, incandescent, gas discharge (e.g., a compact fluorescent lamp (CFL)), arc, LED, laser diode, and other types of bulbs, lamps and globes of any standard shape or size. For example, the housing may be substantially shaped like a standard 120 V or 230 V incandescent general service or high wattage general service light bulb (e.g., general (A), mushroom, elliptical (E), sign (S), tubular (T), pear shaped (PS)), a decorative style bulb (e.g., candle (B), twisted candle, bent-tip candle (CA & BA), flame (F), globe (G), lantern chimney (H), fancy round (P)), a reflective type bulb (e.g., standard reflector (R), elliptical reflector (ER), flood types (FL), spot types (SP), parabolic aluminized reflector (PAR), multifaceted reflector (MR)), etc. The term “substantially shaped” as used herein refers to housings having the overall outermost shape, profile, or form factor of a light bulb, but allowing for minor deviations and/or alterations. Such deviations and/or alterations may include, for example, protrusions, recesses, or surface textures to accommodate, for example, access panels, device installation and removal, switches or other control devices mounted internally or externally, lenses, sound ports, and/or other devices, as well as minor non-functional style deviations. For example, housing 102 may be substantially shaped like a helical CFL by substantially retaining the outermost dimensions of the CFL (e.g., a volume substantially defined by rotating the CFL 360 degrees about an axis passing longitudinally through the base and helical tube structure) without necessarily retaining the exact shape of the helical lamp structure.

Housing 102 may be formed from any suitable material depending on the particular application, such as, for example, such as metal, plastic, ceramics, glass, fiberglass, Plexiglass, or compounds and synthetics based thereon. Housing 102 may be opaque, transparent, translucent, or a combination thereof. For example, housing 102 may include a generally opaque plastic housing with a transparent plastic or glass structure formed therein (e.g., to accommodate an internal light source). Housing 102 may be formed and shaped in any suitable manner. For example, adjustment member 102 may be molded, cast, extruded and machined, etc. Housing 102 may be substantially hollow, substantially solid with compartments or other structures formed therein, filled with appropriate sealing materials, etc.

Housing 102 may include a base 104. Base 104 may be used to couple housing 102 to a light socket. For example, base 104 may be a standard size lamp base, such as an Edison screw (ES) threaded base, a bayonet base, a bi-post base, a bi-pin base, a GU24 type base, or other type of lamp base designed to mate with a corresponding light socket. Base 104 may be secured to housing 102 with, for example, an adhesive, by mechanical crimping to housing 104. Base 104 may include suitable electrically conductive structures such that electric current may be transferred to devices electrically coupled to base 104 when housing 102 is coupled to a light socket. For example, base 104 may be a standard ES base having a conductive threaded portion that is connected to neutral conductor in a light socket and an isolated contact on the bottom tip of base 104 that is connected to a hot conductor in the light socket.

Security device 100 may also include an audible device 106. Audible device 106 may be, for example, a speaker that reproduces sounds received as electrical signals from another source (e.g., wirelessly), or an audible alarm device such as a siren, buzzer, horn, or other type of audible alarm device capable of generating its own sounds at, for example, a desired frequency and/or decibel level. Audible device 106 may be mounted within housing 102 (e.g., to a structural member 108 of housing 102). In some embodiments, audible device 102 may be mounted entirely within housing 102. In such embodiments, housing 102 may include openings that are appropriately sized and positioned to allow sound to escape. Mounting audible device 106 entirely within the housing may allow the security device to avoid interference issues when used with light fixtures having shrouds designed for use with standard bulbs or lamps that may cover or conceal portions of the security device.

Audible device 106 may also be electrically coupled to base 104 (e.g., via conductive members 110). For example, audible device 106 may be an alarm that conducts electric current in order to produce audible sounds when a voltage is applied via conductive members 110. Electrically coupling audible device 106 to base 104 may facilitate control of audible device 106 by a motion sensing device in order to provide an alarm feature. For example, base 104 may be coupled to a mating light socket of a motion sensing security light fixture such that electric current may be transferred to an audible alarm device 106 coupled to base 104. In particular, the motion sensing security light fixture may apply a voltage to base 104 whenever motion is detected by a motion sensing device in the motion sensing security light. As such, audible alarm device 106 may conduct electric current via conductive members 110 and produce audible sounds whenever motion is detected by the motion sensing device.

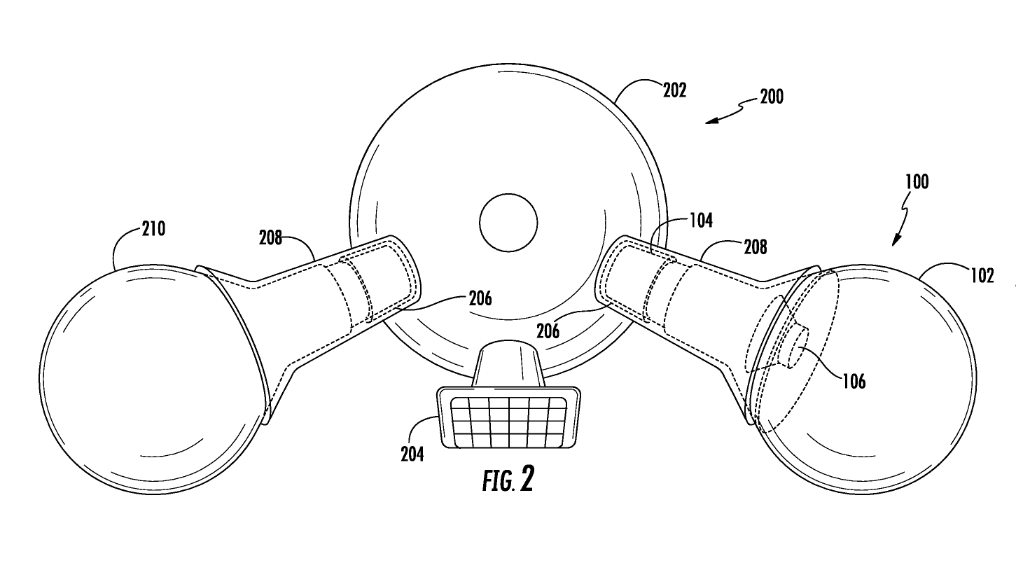

FIG. 2 illustrates security device 100 installed in an example motion sensing security light fixture 200. As illustrated in FIG. 2, motion sensing security light fixture 200 may include a mounting base 202 that may be used to mount motion sensing security light fixture 200 to an appropriate structure. Motion sensing security light fixture 200 may also include a motion sensing device 204 that generates a voltage whenever it detects motion within a certain range. Motion sensing security light fixture may also include light sockets 206 positioned within shrouds 208. Light sockets 206 and shrouds 208 may be sized to receive a standard light bulb 210. As shown in FIG. 2, security device 100 may be coupled to one of light sockets 206 in place of standard light bulb 210 to provide motion sensing security light fixture 200 with an audible alarm feature. Motion sensing security light fixture 200 may apply a voltage to base 104 via socket 206 whenever motion is detected by motion sensing device 204. As such, audible alarm device 106 may conduct electric current and produce audible sounds whenever motion is detected by motion sensing device 204.

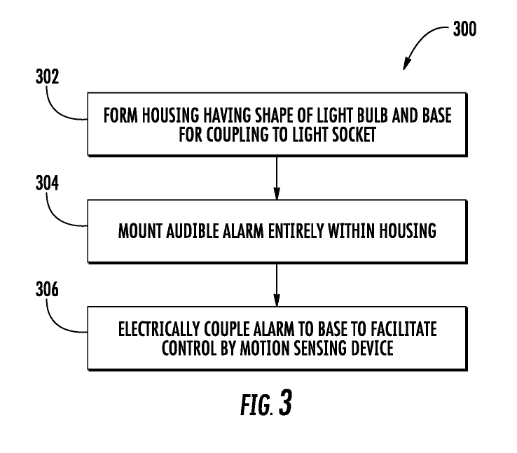

FIG. 3 is a flow diagram illustrating an example method 300 of manufacturing security device 100. As indicated by a step 302, a housing having substantially the shape of light bulb and a base may be for coupling the housing to a light socket may be formed. At a step 304, an audible alarm may be mounted entirely within the housing. At a step 306, the audible alarm may be electrically coupled to the base to facilitate control of the audible alarm by a motion sensing device.

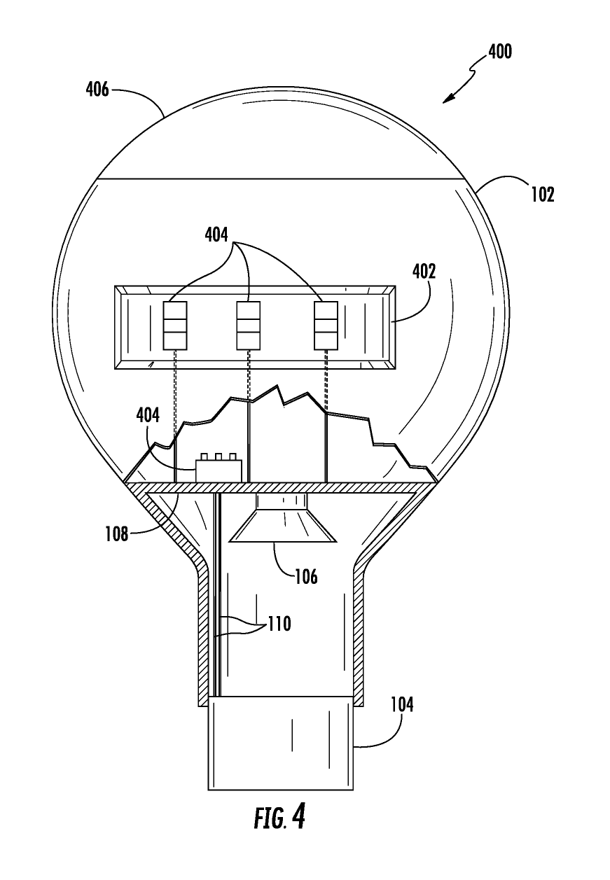

FIG. 4 is a diagram illustrating an example security device 400 including an example control device for controlling an operating parameter of the security device. Security device 400 is similar to security device 100 (shown in FIG. 1) in that it may include housing 102, base 104, and an audible device 106 mounted within housing 102 (e.g., to a structural member 108) and electrically coupled to base 104 (e.g., via conductive members 110). Security device 400 may also include an outer surface 402 of housing 102 including externally accessible control devices 404 supported by housing 102 and electrically coupled to audible device 106 to control an operating parameter of security device 400. For example, externally accessible control devices 404 may include switches, potentiometers, or other devices (e.g., buttons, toggle switchers, DIP switches, etc.) suitably arranged and connected to turn audible device 106 on or off, to test audible device 106 (e.g., a momentary contact switch), or to adjust the volume, pitch, duty cycle, frequency, and duration of audible device 106. Externally accessible control devices 404 may be mounted on or integrated with outer surface 402 of housing 102 and/or may be disposed internally and accessible from outside housing 102 by removing a cover panel 406 of housing 102. In some examples, member 108 may be a circuit board to which audible device 106 and control devices 404 are mounted and/or electrically coupled, and to which base 104 is electrically coupled. In some examples, member 108 may also include power control or conversion circuitry, logic circuitry, and any other electrical or electronic components.

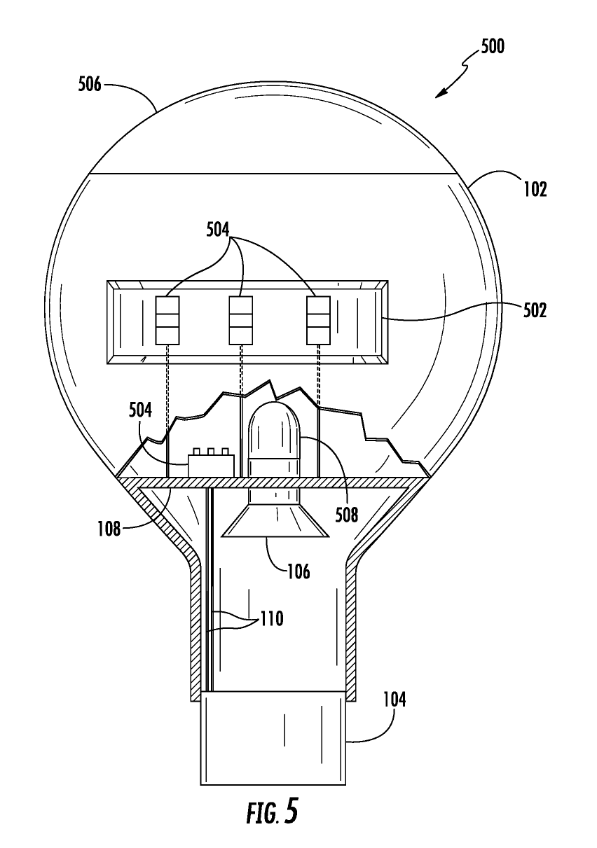

FIG. 5 is a diagram illustrating an example security device 500 including an example light source. Security device 500 is similar to security device 100 (shown in FIG. 1) in that it may include housing 102, base 104, and an audible device 106 mounted within housing 102 (e.g., to a structural member 108) and electrically coupled to base 104 (e.g., via conductive members 110). Similar to security device 400, security device 500 may optionally include an outer surface 502 of housing 102 including externally accessible control devices 504 supported by housing 102 and electrically coupled to audible device 106 to control an operating parameter of security device 500. Externally accessible control devices 504 may be mounted on or integrated with outer surface 502 of housing 102, or may be disposed internally and accessible from outside housing 102 by removing a cover panel 506 of housing 102. In some examples, member 108 may be a circuit board to which audible device 106 and control devices 504 are mounted and/or electrically coupled, and to which base 104 is electrically coupled. In some examples, member 108 may also include power control or conversion circuitry, logic circuitry, and any other electrical or electronic components.

Security device 500 may also include a light source 508. Light source may be any suitable light source depending on the particular application. For example, light source 508 may be an incandescent, gas discharge, arc, LED, laser diode, or other type of light source. Light source 508 may be mounted within housing 102 and electrically coupled to base 104 (e.g., member 108 may be a circuit board on which light source 508 is mounted and/or electrically coupled. In some examples, panel 506 may be, for example, a lens or other transparent or translucent device for passing the light emitted by light source 508. In some examples, externally accessible control devices 504 may include devices such as switches or potentiometers suitably arranged and connected in order to, for example, turn light source 508 on or off, to test light source 508, to adjust the intensity, duty cycle, frequency, and duration of the light source (e.g., light source 508 may function as a flashing light, a strobe light, etc.). In some embodiments, panel 506 may be a fixed lens or other or other transparent or translucent device for passing the light emitted by light source 508, and a separate access panel may be provided for accessing any internally mounted control devices 504.

Electrically coupling light source 508 to base 104 may facilitate control of light source 508 by a motion sensing device, such that an alarm feature may be added while retaining a light source in the same light socket of a light fixture. For example, base 104 may be coupled to a mating light socket of a motion sensing security light fixture such that electric current may be transferred from the light fixture to audible device 106 and light source 508. In particular, the motion sensing security light fixture may apply a voltage to base 104 whenever motion is detected by a motion sensing device in the motion sensing security light. As such, audible alarm device 106 and light source 508 may conduct electric current via conductors 110 and produce audible sounds and light whenever motion is detected by the motion sensing device.

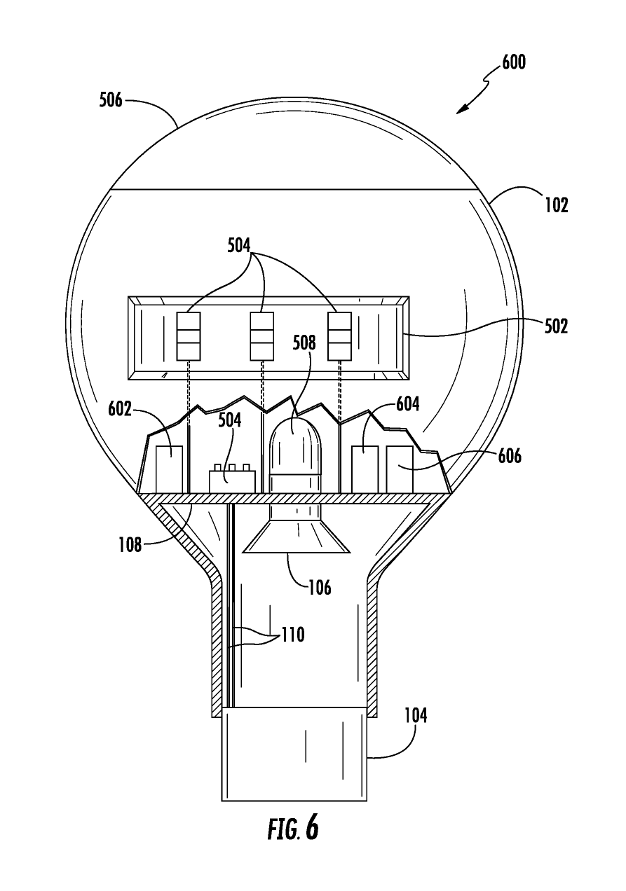

FIG. 6 is a diagram illustrating an example security device 600 including example additional functions. Security device 600 is similar to security device 100 (shown in FIG. 1) in that it may include housing 102, base 104, and an audible device 106 mounted within housing 102 (e.g., to a structural member 108) and electrically coupled to base 104 (e.g., via conductive members 110). Similar to security device 500, security device 600 may optionally include externally accessible control devices 504 supported by housing 102 and electrically coupled to audible device 106 to control an operating parameter of security device 600. In some examples, member 108 may be a circuit board to which audible device 106 and control devices 504 are mounted and/or electrically coupled, and to which base 104 is electrically coupled. In some examples, member 108 may also include power control or conversion circuitry, logic circuitry, and any other electrical or electronic components.

Security device 600 may also include a light source 508. In one implementation, light source 508 comprises a single light emitting element. In another implementation, light source 508 comprises multiple light emitting elements, such as multiple light emitting diodes. In one implementation, the multiple light emitting elements turn off and turn on in unison. In another implementation, each of the multiple light emitting elements are actuatable between on and off states independent of one another. In such implementations, different numbers of light emitting elements are selectively turned on (or selectively turned off) in response to an based upon signals received from motion sensing device 602, camera 604, and/or photosensor 606 (described below). For example, when security has been breached and warnings are to be provided, a greater number of the light emitting elements may be actuated to an onstate. In one implementation, two or more of the multiple light emitting elements emit different colors of light or emit light at different frequencies. In such an implementation, a circuit controller automatically selects and actuates a particular one of the multiple light emitting elements based upon a determined security level.

For example, in a low security or low risk circumstance, a light emitter emitting a white light may be actuated. In a high-security or high risk circumstance, as determined by a controller based upon signals from one or more sensors, such as motion sensing device 602, the controller may automatically actuate a different light emitter, from the set of multiple light emitters, that emits a red light or a blue light, or a flashing light to indicate the high risk circumstance. In one implementation, a particular one of the multiple light emitting elements, such as LEDs, is automatically actuated to an on state in response to signals from motion sensor 602 or other sensing devices. For example, in one implementation, a user may input or select a high security mode, such as when the user or owner is expected to be away from a residence or business, such as on vacation or a prolonged trip. When in the “high security mode”, motion detected by motion sensor 602 automatically triggers actuation of one or more light emitting elements that emit a warning color such as blue or red or that emit a flashing or strobe light. In contrast, when the person is anticipating being around or is there is less risk, user may input or select a low security mode. When in the “low security mode”, motion detection by motion sets 602 automatically triggers actuation of other light emitting elements that emit other colors of light such as white light or a non-pulsed or non-strobed frequency of light.

In some implementations, security device 600 may comprise a wireless transceiver and a circuit board (internal to housing 102 or external to housing 102) that facilitate wireless actuation of security device 600 between different security states or modes, such as the aforementioned high and low security modes. In one implementation, the wireless receiver or wireless transceiver facilitates actuation of security device 600 between different states or modes using signals from a portable electronic device, such as a smart phone, laptop, tablet computer, personal data assistant, cell phone or the like. Some implementations, the wireless receiver or wireless transceiver (or a wired connection) facilitate switching of security device 600 between different states or security modes upon receiving control signals across a local area network or a wide area network, such as the Internet.

In some examples, panel 506 may be, for example, a lens or other transparent or translucent device for passing the light emitted by light source 508. In some examples, externally accessible control devices 504 may include devices such as switches or potentiometers suitably arranged and connected in order to, for example, turn light source 508 on or off, to test light source 508, to adjust the intensity, duty cycle, frequency, and duration of the light source (e.g., light source 508 may function as a flashing light, a strobe light, etc.).

Security device 600 may also include a motion sensing device 602 mounted within housing 102 and electrically coupled to base 104 (e.g., motion sensing device 602 may be mounted and/or electrically coupled to circuit board 108). Motion sensing device 602 may apply a voltage to audible device 106 and/or light source 508 whenever motion is detected by motion sensing device 602. As such, audible device 106 and/or light source 508 may conduct electric current and produce audible sounds and light whenever motion is detected by motion sensing device 602. In this way, security device 600 may be used to convert light fixtures that do not have motion sensing function into motion sensing security light fixtures having an added alarm function.

Security device 600 may also include a camera 604 mounted within housing 102 and electrically coupled to base 104 (e.g., camera 604 may be mounted and/or electrically coupled to circuit board 108). Camera 604 may include wireless capability such that images and/or video captured by camera 604 may be wirelessly transmitted to, stored by, and/or viewed using a remote electronic device. Electrically coupling camera 604 to base 104 may facilitate control of camera 604 by a motion sensing device, such that a video feature may be added. For example, base 104 may be coupled to a mating light socket of a motion sensing security light fixture such that electric current may be transferred from the light fixture to camera 604. In particular, the motion sensing security light fixture may apply a voltage to base 104 whenever motion is detected by a motion sensing device in the motion sensing security light. In this way, camera 604 may capture images or video whenever motion is detected by a motion sensing device in the motion sensing security light. Similarly, in examples where security device 600 includes a motion sensing device 602 mounted within housing 102 and electrically coupled to base 104, security device 600 may be used to convert light fixtures that do not have motion sensing function into motion sensing security light fixtures having an added camera function.

Security device 600 may also include a photosensor 606 mounted within housing 102 and electrically coupled to light source 508 (e.g., photosensor 606 may be mounted and/or electrically coupled to circuit board 108). Photosensor 606 may, for example, allow for automated and efficient enabling of a light source feature based on lighting conditions.

While examples of the invention have been illustrated and described, it will be appreciated that various changes can be made therein without departing from the spirit and scope of the invention. For example, although different examples may have been described as including features providing benefits, it is contemplated that the described features may be interchanged with one another or alternatively be combined with one another in the described examples or in other examples. One of skill in the art will understand that the invention may also be practiced without many of the details described above. Accordingly, it will be intended to include all such alternatives, modifications and variations set forth within the spirit and scope of the appended claims. Further, some well-known structures or functions may not be shown or described in detail because such structures or functions would be known to one skilled in the art. Unless a term is specifically and overtly defined in this specification, the terminology used in the present specification is intended to be interpreted in its broadest reasonable manner, even though may be used conjunction with the description of certain specific examples of the present invention.

What is claimed is:

1. An apparatus, comprising:
a housing having substantially the shape of a light bulb and including a base for coupling the housing to a light socket; and
an audible alarm mounted entirely within the housing and electrically coupled to the base to facilitate control of the audible alarm by a motion sensing device.

2. The apparatus of claim 1, wherein base is threaded.

3. The apparatus of claim 1, further comprising an externally accessible control device supported by the housing and electrically coupled to the audible alarm to control an operating parameter of the audible alarm.

4. The apparatus of claim 1, further comprising a light source mounted within the housing and electrically coupled to the base.

5. The apparatus of claim 4, wherein the housing includes a lens.

6. The apparatus of claim 5, further comprising an externally accessible switch supported by the housing and electrically coupled to one of the light source and the audible alarm to control an operating parameter of the one of the light source and the audible alarm.

7. The apparatus of claim 1, further comprising the motion sensing device, wherein the motion sensing device is mounted within the housing and electrically coupled to the base.

8. The apparatus of claim 1, further comprising a camera mounted within the housing and electrically coupled to the base.

9. An apparatus, comprising:
a motion sensing device;
a housing having substantially the shape of a light bulb and including a base for coupling the housing to a light socket; and
an audible device mounted entirely within the housing and electrically coupled to and controlled by the motion sensing device.

10. The apparatus of claim 9, wherein the motion sensing device includes the light socket, and wherein the audible device is electrically coupled to the motion sensing device via the base.

11. The apparatus of claim 9, wherein the motion sensing device is mounted within the housing and electrically coupled to the base.

12. The apparatus of claim 9, further comprising a light source mounted within the housing and electrically coupled to the motion sensing device.

13. The apparatus of claim 12, wherein the housing includes a lens.

14. The apparatus of claim 13, further comprising a photosensor mounted within the housing and electrically coupled to the light source.

15. An apparatus, comprising:
a housing having substantially the shape of a light bulb and including a base for coupling the housing to a light socket;
an audible device mounted entirely within the housing and electrically coupled to the base to facilitate control of the audible device by a motion sensing device; and
an externally accessible control device supported by the housing and electrically coupled to the audible device to control an operating parameter of the audible device.

16. The apparatus of claim 15, wherein the externally accessible control device is one of a switch and a potentiometer for controlling the operating parameter of the audible device.

17. The apparatus of claim 15, wherein the control device is one of an ON/OFF switch and a test switch for the audible device.

18. The apparatus of claim 16, wherein the operating parameter of the audible device is one of a volume, a pitch, a duty cycle, a frequency, and a duration.

19. The apparatus of claim 15, further comprising a light source mounted within the housing and electrically coupled to the base, and an externally accessible control device supported by the housing and electrically coupled to the light source to control an operating parameter of the light source.

20. The apparatus of claim 15, wherein the operating parameter of the light source is one of an intensity, a duty cycle, a frequency, and a duration.
